(19) United States
(12) Patent Application Publication
(10) Pub. No.: US 2014/0102242 A1
(43) Pub. Date: Apr. 17, 2014

(54) Connecting and Disconnecting Structure for a Brake Cable

(71) Applicant: Sung-Nan Chen, Changhua County (TW)

(72) Inventor: Sung-Nan Chen, Changhua County (TW)

(21) Appl. No.: 14/043,254

(22) Filed: Oct. 1, 2013

(30) Foreign Application Priority Data
Oct. 17, 2012 (TW) 10122004

(51) Int. Cl. F16C 1/10

(52) U.S. Cl. CPC F16C 1/102
USPC 74/502.2; 74/502.6

(57) ABSTRACT

A connecting and disconnecting structure for a brake cable contains a braking assembly, an adjustable positioning device, and a brake cable. The braking assembly includes a first orifice for receiving the adjustable positioning device, the brake cable has at least one segment inserted into and retained by the adjustable positioning device. The adjustable positioning device includes: an external sleeve having a first end, a second end, and an increased conical aperture extending from the first end to the second end; a sliding post inserted into the increased conical aperture and having a through bore, plural conical openings equidistantly arranged on the sliding post, and another end extending out of the external sleeve; plural balls fixed in the plural conical openings; a resilient element fitted in the increased conical aperture so that the sliding post is pushed by the resilient element to move toward the first end of the external sleeve.

### BACKGROUND OF THE INVENTION

1. Field of the Invention

The present invention relates to a braking system, and more particularly to a connecting and disconnecting structure for connecting or disconnecting a brake lever and a brake arm.

2. Description of the Prior Art

A conventional braking system for a two-wheel vehicle has two different brake levers for connecting with a front brake device and a rear brake device via a brake cable, thereby controlling the front brake device and the rear brake device.

A conventional brake cable has a head end and a distal end, wherein the head end is die casted to form a head protrusion which is used to retain the lever. The distal end of the brake cable is in connection with an adjustable driving rod of the front brake device and the rear brake device, and the adjustable driving rod inserts through a through hole of a brake arm to screw with a fixing nut, such that the fixing nut fixes the adjustable driving rod, and as rotating the fixing nut, the adjustable driving rod is driven by the fixing nut to move frontward and backward, thus adjusting a tightness of the brake cable. Alternatively, the distal end of the brake cable inserts through two orifices of the front brake device and the rear brake device so as to position a screw, and the screw inserts through an aperture of the brake arm so as to screw with a forcing nut, such that the screw retains the brake cable, hence when unscrewing the forcing nut, a tightness of the brake cable is adjusted.

However, the brake cable, the brake lever, the front brake device, and the rear brake device are adjusted troublesomely and have complicated structure, thereby increasing assembly time and production cost.

The present invention has arisen to mitigate and/or obviate the afore-described disadvantages.

### SUMMARY OF THE INVENTION

The primary object of the present invention is to provide a connecting and disconnecting structure for a brake cable in which a brake cable is inserted into a through bore of a sliding post of an adjustable positioning device and is retained by a plurality of balls, thus adjusting a tightness of the brake cable easily and quickly.

Another object of the present invention is to provide a connecting and disconnecting structure for a brake cable in which the brake cable is inserted into the through bore of the sliding post of the adjustable positioning device and is retained by the plurality of balls, so a first segment or a second segment of the brake cable will not be die casted to form a head portion, thus simplifying structure and lowering production cost.

To obtain the above objectives, a connecting and disconnecting structure for a brake cable contains: a braking assembly, an adjustable positioning device, and a brake cable, wherein the braking assembly include a first orifice for receiving the adjustable positioning device, the brake cable has at least one segment inserted into and retained by the adjustable positioning device.

The adjustable positioning device includes:

an external sleeve formed in a hollow tube shape and having a first end and a second end, the external sleeve having an increased conical aperture extending from the first end to the second end;

a sliding post inserted into the increased conical aperture of the external sleeve and having a through bore formed therein, a plurality of conical openings equidistantly arranged on one end of the sliding post, and another end extending out of the external sleeve;

a plurality of balls fixed in the plurality of conical openings;

a resilient element fitted in the increased conical aperture of the external sleeve so that the sliding post is pushed by the resilient element to move toward the first end of the external sleeve.

### BRIEF DESCRIPTION OF THE DRAWINGS

FIG. 1 is a perspective view showing the assembly of a connecting and disconnecting structure for a brake cable according to a preferred embodiment of the present invention.

FIG. 2 is a perspective view showing the exploded components of a brake lever of the connecting and disconnecting structure for the brake cable according to the preferred embodiment of the present invention.

FIG. 3 is a cross sectional view showing the assembly of the brake lever of the connecting and disconnecting structure for the brake cable according to the preferred embodiment of the present invention.

FIG. 4 is a perspective view showing the exploded components of a brake arm of the connecting and disconnecting structure for the brake cable according to the preferred embodiment of the present invention.

FIG. 5 is a cross sectional view showing the assembly of the brake arm of the connecting and disconnecting structure for the brake cable according to the preferred embodiment of the present invention.

FIG. 6 is a cross sectional view showing the operation of the brake lever of the connecting and disconnecting structure for the brake cable according to the preferred embodiment of the present invention.

FIG. 7 is another cross sectional view showing the operation of the brake lever of the connecting and disconnecting structure for the brake cable according to the preferred embodiment of the present invention.

FIG. 8 is also another cross sectional view showing the operation of the brake lever of the connecting and disconnecting structure for the brake cable according to the preferred embodiment of the present invention.

FIG. 9 is a cross sectional view showing the operation of the brake arm of the connecting and disconnecting structure for the brake cable according to the preferred embodiment of the present invention.

FIG. 10 is another cross sectional view showing the operation of the brake arm of the connecting and disconnecting structure for the brake cable according to the preferred embodiment of the present invention.

FIG. 11 is also another cross sectional view showing the operation of the brake arm of the connecting and disconnecting structure for the brake cable according to the preferred embodiment of the present invention.

FIG. 12 is still another cross sectional view showing the operation of the brake arm of the connecting and disconnecting structure for the brake cable according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

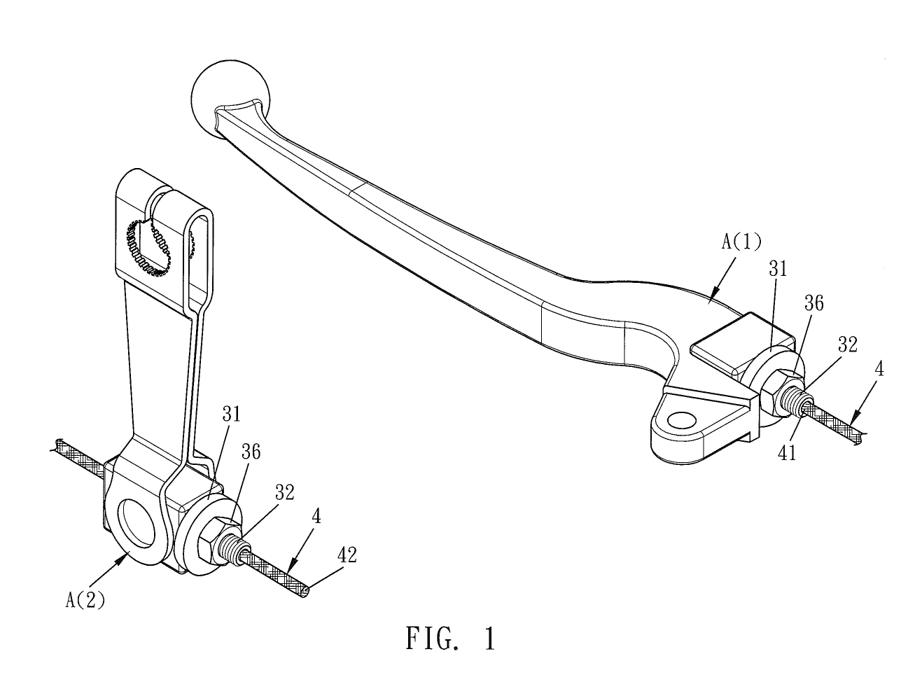

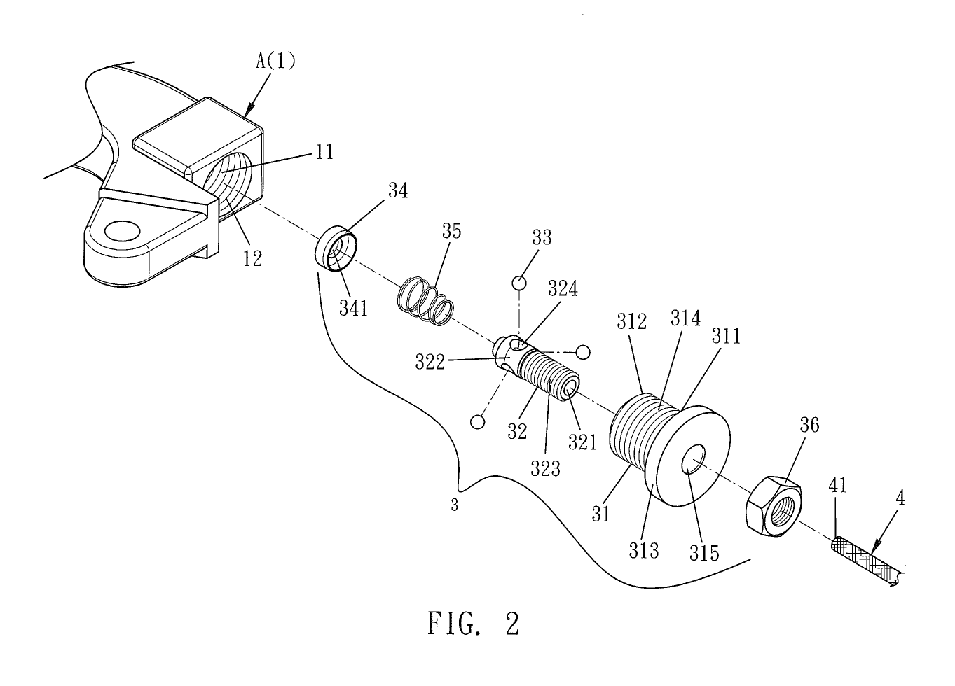

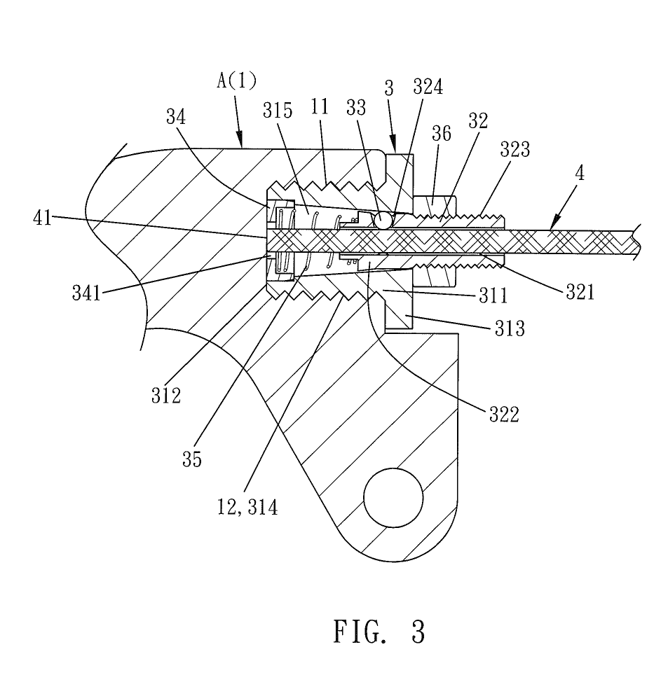

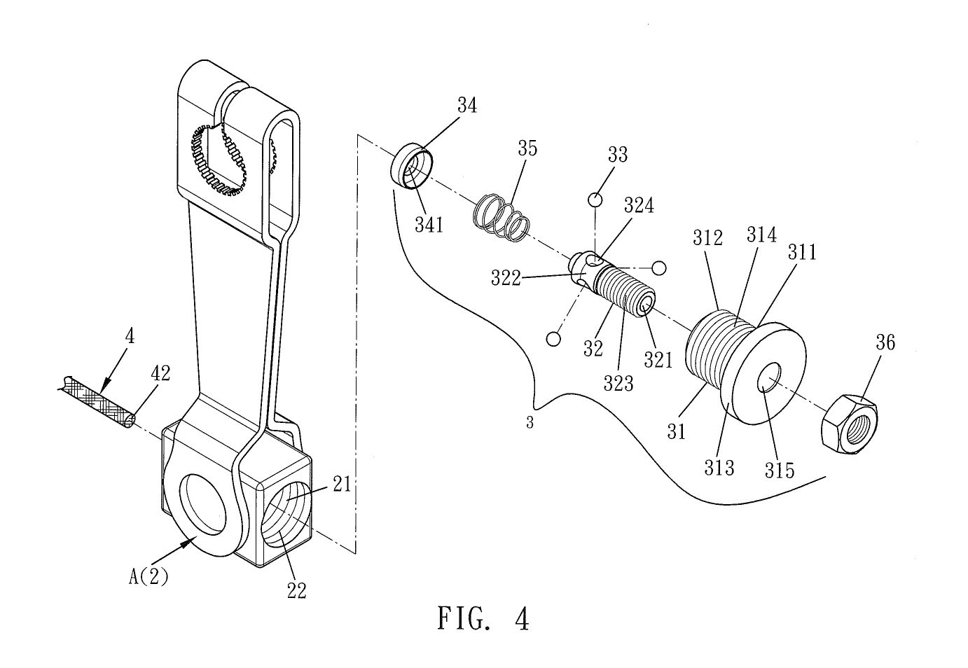

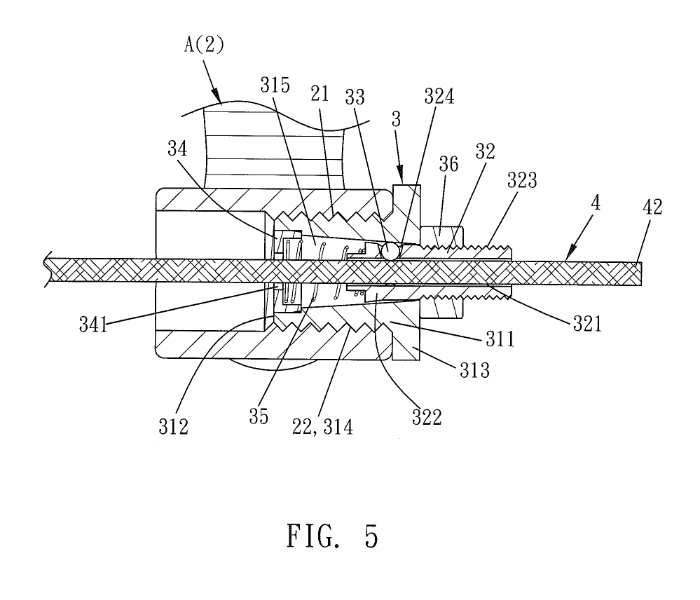

With reference to FIGS. 1-5, a connecting and disconnecting structure for a brake cable according to a preferred embodiment of the present invention comprises: a braking assembly A, an adjustable positioning device 3, and a brake cable 4.

The braking assembly A is a brake lever 1 or a brake arm 2, the brake lever 1 includes a first orifice 11 or the brake arm 2 includes a second orifice 21 for receiving the adjustable positioning device 3, wherein the first orifice 11 of the brake lever 1 is a blind hole in which first inner threads 12 are defined, and the second orifice 21 of the brake arm 2 is a through hole in which second inner threads 22 are defined.

The adjustable positioning device 3 includes an external sleeve 31, a sliding post 32, a plurality of balls 33, a cap 34, a resilient element 35, and a nut 36. The external sleeve 31 is formed in a hollow tube shape and has a first end 311 and a second end 312, wherein the first end 311 has a circular tab 313, and between the first end 311 and the second end 312 is defined a screwing section 314 for screwing with the first inner threads 12 of the first orifice 11 or the second inner threads 22 of the second orifice 21. In addition, the external sleeve 31 has an increased conical aperture 315 extending from the first end 311 to the second end 312 so that the sliding post 32 inserts into the increased conical aperture 315 of the external sleeve 31 from the second end 312 of the external sleeve 31. The sliding post 32 has a through bore 321 formed therein, a large diameter portion 322 arranged on one end thereof and formed in a cone shape, and a threaded section 323 formed on another end thereof and extending out of the increased conical aperture 315 of the external sleeve 31, such that the large diameter portion 322 prevents the sliding post 32 from disengagement from the first end 311 of the external sleeve 31. Furthermore, the large diameter portion 322 has a plurality of conical openings 324 equidistantly arranged thereon and communicating with the through bore 321 of the sliding post 32, wherein the plurality of balls 33 are made of metal material and are fixed in the plurality of conical openings 324 of the sliding post 32. The cap 34 is mounted on a large diameter end of the increased conical aperture 315 of the external sleeve 31 and has an eyelet 341 defined therein so as to insert the brake cable 4, the resilient element 35 is a spring fitted in the increased conical aperture 315 and located between the sliding post 32 and the cap 34, such that the sliding post 32 is pushed by the resilient element 35 to move toward the first end 311 of the external sleeve 31. The nut 36 screws with a predetermined portion of the threaded section 323 of the sliding post 32 which extends out of the increased conical aperture 315 of the external sleeve 31.

The brake cable 4 has a first segment 41 and a second segment 42 inserted into the through bore 321 of the sliding post 32 of the adjustable positioning device 3 and retained by the plurality of balls 32 in the plurality of conical openings 324 of the large diameter portion 322 of the sliding post 32.

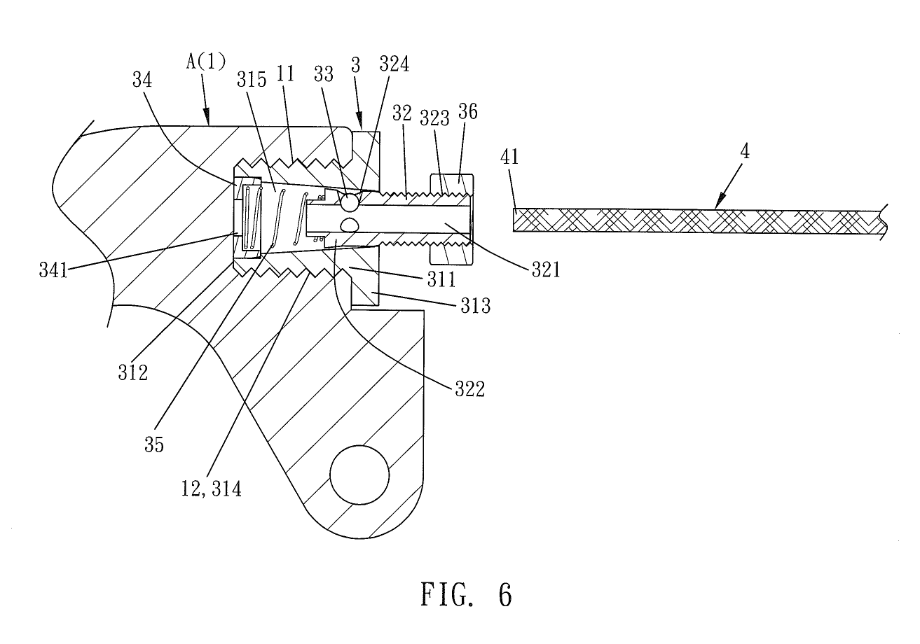

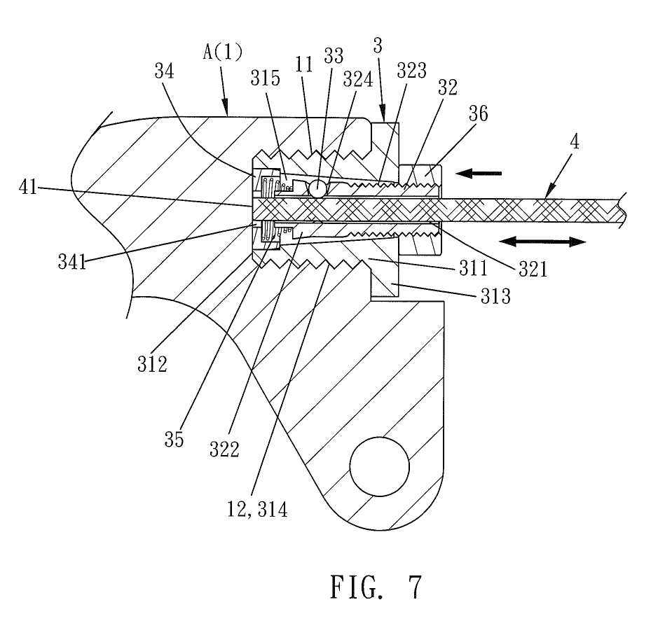

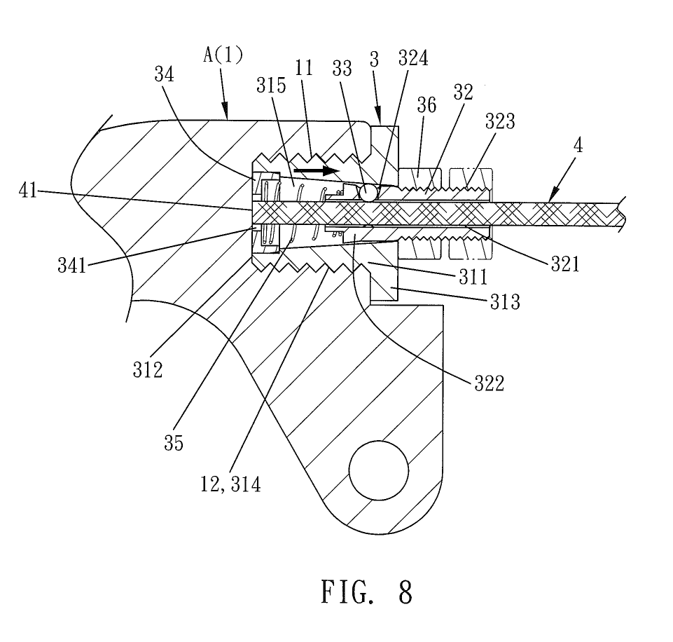

Referring further to FIGS. 6-8, as connecting the first segment 41 of the brake cable 4 with the brake lever 1, the nut 36 of the adjustable positioning device 3 in the first orifice 11 of the brake lever 1 is unscrewed on the threaded section 323 of the sliding post 32 so as to move away from the external sleeve 31, and the threaded section 323 of the sliding post 32 is pushed into the increased conical aperture 315 so that the sliding post 32 moves toward the cap 34 to press the resilient element 35, in the meantime, the plurality of balls 33 do not engage with the increased conical aperture 315, and then the first segment 41 of the brake cable 4 is inserted into the through bore 321 of the sliding post 32, thereafter the sliding post 32 is released so that the resilient element 35 pushes the sliding post 32 and the nut 36 to move outwardly, hence the plurality of balls 33 are forced by the increased conical aperture 315 so as to move inwardly to retain the brake cable 4. Also, the nut 36 is screwed on the sliding post 32 so as to move toward the external sleeve 31, such that the nut 36 contacts with the circular tab 313 of the first end 311 of the external sleeve 31 so that the sliding post 32 is fixed securely without moving back to the increased conical aperture 315, thus preventing the brake cable 4 from disengagement.

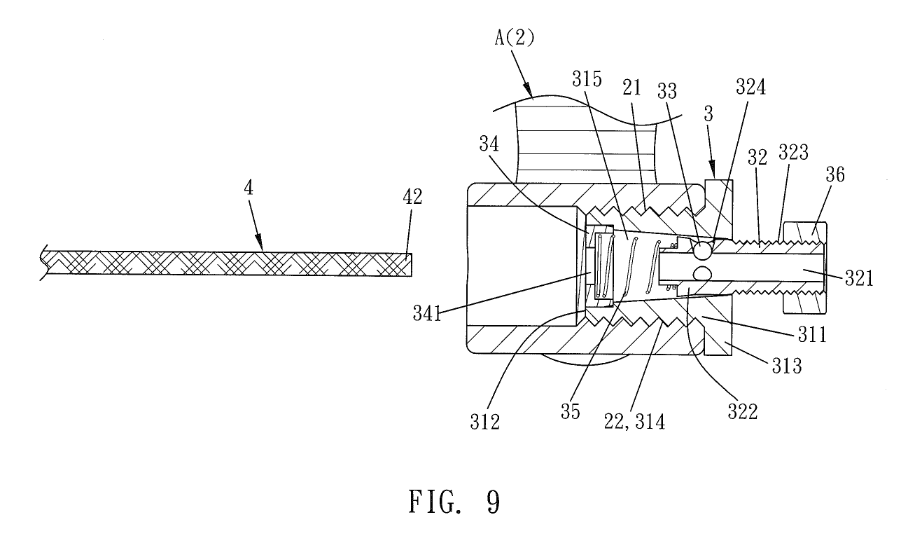

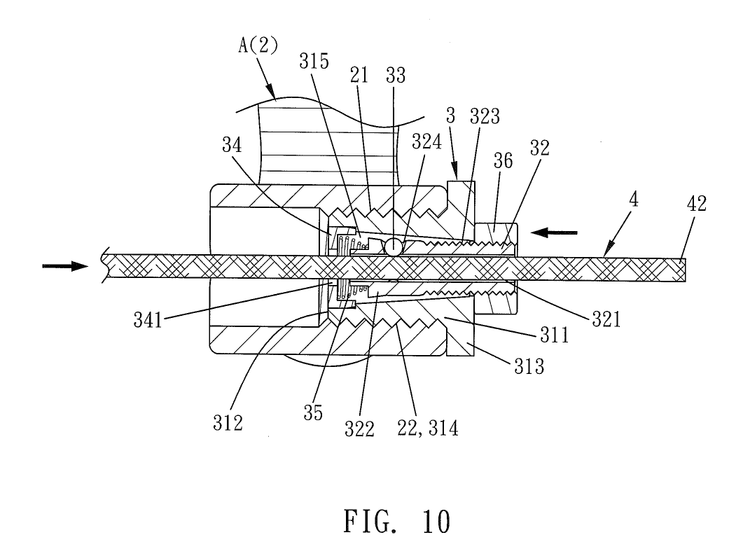

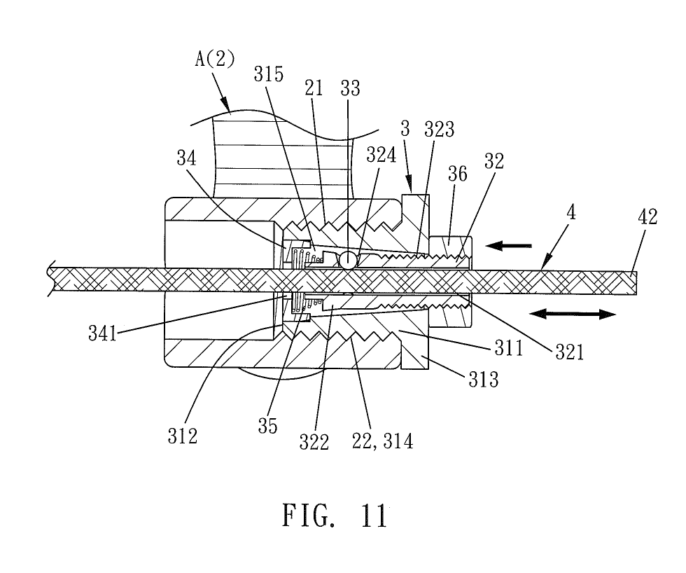

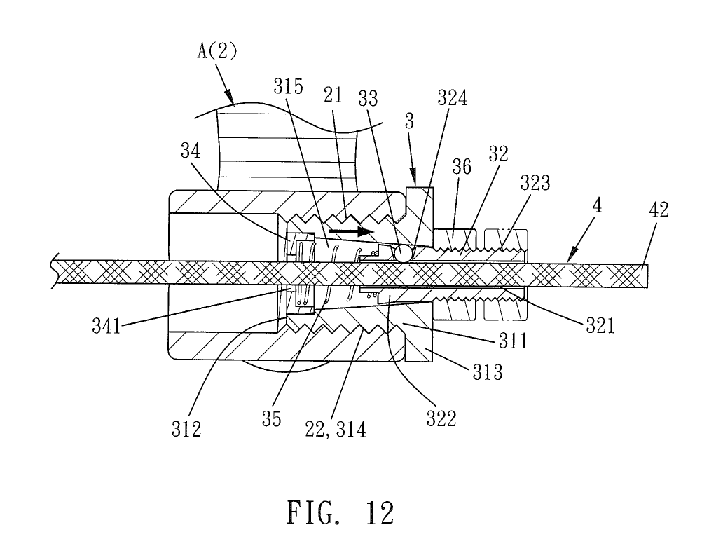

As shown in FIGS. 9-12, as connecting the second segment 42 of the brake cable 4 with the brake arm 2, the nut 36 of the adjustable positioning device 3 in the second orifice 21 of the brake arm 2 is unscrewed on the threaded section 323 of the sliding post 32 so as to move away from the external sleeve 31, and the threaded section 323 of the sliding post 32 is pushed into the increased conical aperture 315 so that the sliding post 32 moves toward the cap 34 to press the resilient element 35, in the meantime, the plurality of balls 33 do not engage with the increased conical aperture 315, and the second segment 42 of the brake cable 4 is inserted into the through bore 321 of the sliding post 32 via the eyelet 341 of the cap 34, then the brake cable 4 is pulled to adjust its tightness, thereafter the sliding post 32 is released so that the resilient element 35 pushes the sliding post 32 and the nut 36 to move outwardly, hence the plurality of balls 33 are forced by the increased conical aperture 315 so as to move inwardly to retain the brake cable 4. Also, the nut 36 is screwed on the sliding post 32 so as to move toward the external sleeve 31, such that the nut 36 abuts against the circular tab 313 of the first end 311 of the external sleeve 31 so that the sliding post 32 is fixed securely without moving back to the increased conical aperture 315, thus preventing the brake cable 4 from disengagement.

Thereby, the connecting and disconnecting structure of the present invention has the following advantages:

1. The brake cable 4 is inserted into the through bore 321 of the sliding post 32 of the adjustable positioning device 3 and is retained by the plurality of balls 33, thus adjusting the tightness of the brake cable 4 easily and quickly.

2. The brake cable 4 is inserted into the through bore 321 of the sliding post 32 of the adjustable positioning device 3 and is retained by the plurality of balls 33, so the first segment 41 or the second segment 42 of the brake cable 4 will not be die casted to form a head portion, thus simplifying structure and lowering production cost.

While we have shown and described various embodiments in accordance with the present invention, it is clear to those skilled in the art that further embodiments may be made without departing from the scope of the present invention.

What is claimed is:

1. A connecting and disconnecting structure for a brake cable comprising:
a braking assembly, an adjustable positioning device, and a brake cable, wherein the braking assembly include a first orifice for receiving the adjustable positioning device, the brake cable has at least one segment inserted into and retained by the adjustable positioning device, and the adjustable positioning device includes:
an external sleeve formed in a hollow tube shape and having a first end and a second end, the external sleeve having an increased conical aperture extending from the first end to the second end;
a sliding post inserted into the increased conical aperture of the external sleeve and having a through bore formed therein, a plurality of conical openings equidistantly arranged on one end of the sliding post, and another end extending out of the external sleeve;
a plurality of balls fixed in the plurality of conical openings;
a resilient element fitted in the increased conical aperture of the external sleeve so that the sliding post is pushed by the resilient element to move toward the first end of the external sleeve.

2. The connecting and disconnecting structure for the brake cable as claimed in claim 1, wherein the braking assembly is a brake lever, the first orifice of the brake lever is a blind hole in which first inner threads are defined, the external sleeve has a screwing section defined thereon so as to screw with the first inner threads of the first orifice of the brake lever.

3. The connecting and disconnecting structure for the brake cable as claimed in claim 1, wherein the braking assembly is a brake arm, and the brake arm include a second orifice which is a through hole, and the through hole has second inner threads defined therein, the external sleeve has a screwing section defined thereon so as to screw with the second inner threads of the second orifice of the brake arm.

4. The connecting and disconnecting structure for the brake cable as claimed in claim 1, wherein the first end of the external sleeve has a circular tab.

5. The connecting and disconnecting structure for the brake cable as claimed in claim 4, wherein the sliding post has a threaded section formed on another end thereof and extending out of the increased conical aperture of the external sleeve, a predetermined portion of the threaded section of the sliding post screws with a nut and extends out of the external sleeve, such that the nut contacts with the circular tab of the first end of the external sleeve.

6. The connecting and disconnecting structure for the brake cable as claimed in claim 1, wherein the sliding post inserts into the increased conical aperture of the external sleeve from the second end of the external sleeve, the sliding post has a large diameter portion arranged on one end thereof and formed in a cone shape, and the large diameter portion has the plurality of conical openings arranged thereon.

7. The connecting and disconnecting structure for the brake cable as claimed in claim 1, wherein the increased conical aperture of the external sleeve has a cap mounted on a large diameter end thereof, and the cap has an eyelet defined therein so as to insert the brake cable.

8. The connecting and disconnecting structure for the brake cable as claimed in claim 1, wherein the resilient element is a spring.

9. The connecting and disconnecting structure for the brake cable as claimed in claim 1, wherein the brake cable has a first segment and a second segment inserted into the through bore of the sliding post of the adjustable positioning device and retained by the plurality of balls in the plurality of conical openings of the large diameter portion of the sliding post.
